(19) United States
(12) Patent Application Publication
(10) Pub. No.: US 2009/0254967 A1
(43) Pub. Date: Oct. 8, 2009

(54) VIRTUAL PRIVATE NETWORKS (VPN) ACCESS BASED ON CLIENT WORKSTATION SECURITY COMPLIANCE

(76) Inventors: Premkumar J., Tamil Nadu (IN); Vishnu Govind Attur, Bangalore (IN)

Correspondence Address: SCHWEGMAN, LUNDBERG & WOESSNER/NOVELL, PO BOX 2938, MINNEAPOLIS, MN, 55402, US

(21) Appl. No.: 12/060,991

(22) Filed: Apr. 2, 2008

(51) Int. Cl. G06F 17/00; G06F 15/16

(52) U.S. Cl. 726/1; 726/15

(57) ABSTRACT

Techniques for virtual private network (VPN) access, which is based on client workstation security compliance, are provided. When a user successfully logs into a secure network, client integrity checks are processed on a client workstation of the user to gather configuration information related to a processing environment of the client workstation. Metrics associated with the client integrity checks are compared with security policy and an assigned security access level is set for the user during a VPN session. Traffic policy is then enforced against the VPN session by configuring attributes of the VPN session.

### BACKGROUND

Increasing the affairs of individuals and enterprises are being conducted in an automated manner over the Internet. Enterprises now engage in selling their products and services over the Internet; individuals also engage in communicating with one another over the Internet; employees may also engage in accessing secure resources of their employers over the Internet, etc.

When employees access secure assets of an enterprise over the Internet, the enterprise has to ensure that the access is secure. One mechanism to achieve this is via a Virtual Private Network (VPN) connection.

VPN transactions use authentication and encryption techniques for purposes of ensuring that communications are secure. Essentially, a VPN permits insecure communications lines to be used in a secure manner.

Typical VPN-based authentication relies on the ability of the user to properly present sufficient credentials to an enterprise server, such that the enterprise server can assure itself that the user is who the user purports to be.

However, in many cases user authentication standing on its own may be insufficient security for an enterprise. This is so, because increasingly users are accessing enterprise assets via a variety of different devices. A user can log in using a friend's computer to the enterprise. The problem with this is that the friend's computer may lack adequate security software and may in fact contain an existing virus. Once the user successfully authenticates with the enterprise and establishes a VPN, malicious software on the friend's computer could inject a virus into the enterprise's server. In another scenario, the user may access sensitive material during the VPN that could be stored on the friend's computer and the friend's computer may not be deemed secure enough by the enterprise to possess the sensitive material.

Some existing VPN techniques may detect situations such as this and may out right deny a user access to the enterprise. But, sometimes the user only wants to access less secure or minimal assets of the enterprise and is willing to accept limited access to the enterprise network. Unfortunately, existing VPN mechanisms are not this flexible. Thus, the user is either given full access to the enterprise (which may be unacceptable) or the user is given no access to the enterprise (which in some cases may also be unacceptable in a given circumstance).

Consequently, there is a need for improved techniques for VPN access, which accounts for specific user needs in a given circumstance.

### SUMMARY

In various embodiments, techniques for virtual private network (VPN) access, which is based on client workstation security compliance, are provided. In an embodiment, a method for setting security access during a VPN session is provided. More specifically, a successful login of a user into a secure network is detected; the successful login originates from a client workstation. Next, a client integrity check (CIC) is performed against a processing environment of the client workstation. A security access level is then set against the user and the client workstation for use during a virtual private network (VPN) session with resources of the secure network in response to the CIC. Finally, a traffic policy is set for communication between the user and the resources during the VPN session in response to the security access level.

### BRIEF DESCRIPTION OF THE DRAWINGS

FIG. 1 is a diagram of a method for setting security access during a VPN session, according to an example embodiment.

FIG. 2 is a diagram of another method for setting security access during a VPN session, according to an example embodiment.

FIG. 3 is a diagram of a VPN security access establishment system, according to an example embodiment.

FIG. 4 is a diagram of another VPN security access establishment system, according to an example embodiment.

### DETAILED DESCRIPTION

A “resource” includes a user, content, a processing device, a node, a service, an application, a system, a gateway, a directory, a data store, a World-Wide Web (WWW) site, an end-user, groups of users, combinations of these things, etc. The terms “service,” “module,” “software,” and “application” may be used interchangeably herein and refer to a type of software resource that includes instructions, which when executed by a machine performs operations that change the state of the machine and that may produce output.

A “client” or “client workstation” is machine (computer, processing device, etc.) that a user uses to access a secure network. The client includes a processing environment, and the processing environment has a configuration that includes information and setting related to: a type and version of an operating system (OS) installed on the client, a type and version of antivirus software available on the client (if at all), and specific types and versions of software installed and available on the client (if at all). As used herein the terms “client,” “desktop,” “client machine,” “client workstation,” and “workstation” may be used interchangeably and synonymously.

A “server” is a machine that the client interacts with over a network, such as the Internet. The user, via its client, attempts to establish a secure connection with the server, via a Virtual Private Network (VPN) session for purposes of accessing secure resources of the server.

A “virtual private network (VPN)” is a special type of network that is carved out of or tunneled through another network, such as an insecure network like the Internet.

Various embodiments of this invention can be implemented in existing network architectures, storage systems, security systems, data centers, and/or communication devices. For example, in some embodiments, the techniques presented herein are implemented in whole or in part in the Novell® network, proxy server products, email products, operating system products, data center products, and/or directory services products distributed by Novell®, Inc., of Provo, Utah.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

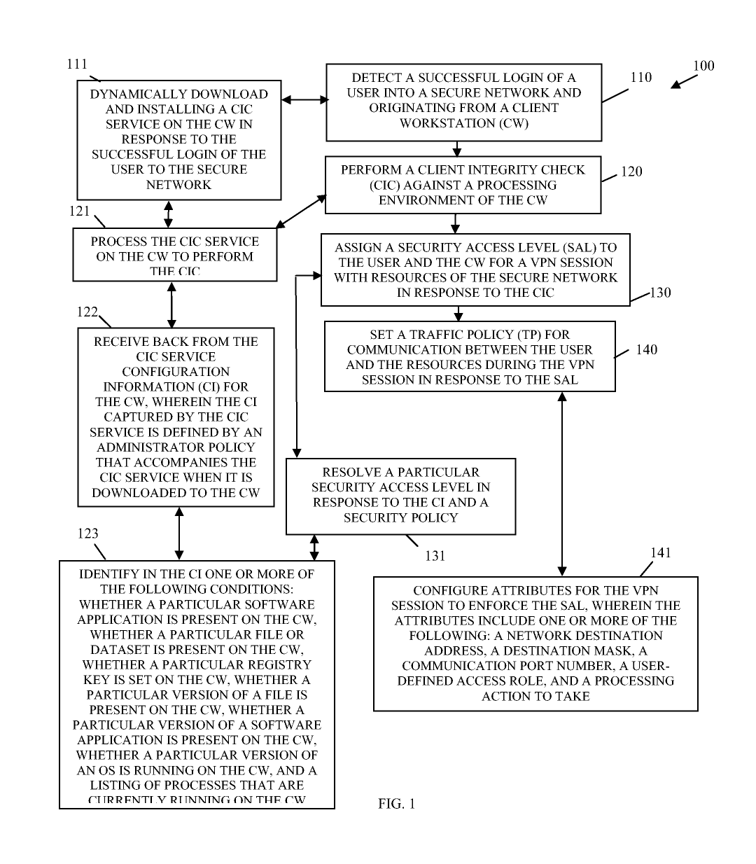

It is within this context, that various embodiments of the invention are now presented with reference to the FIGS. 1-4.

FIG. 1 is a diagram of a method 100 for setting security access during a VPN session, according to an example embodiment. The method 100 (herein after referred to as “VPN security compliance service”) is implemented in a machine-accessible and computer-readable medium and instructions. The instructions when processed by one or more machines (computer, processing device, etc.) perform the processing depicted in the FIG. 1. The VPN security compliance service is operational over a network and the network is wired, wireless, or a combination of wired and wireless.

Client Integrity Checking (CIC) refers to the process of asserting the security compliance of a client workstation with respect to predefined security standards (differs with every organization). As stated above, with the advent of increase in remote access and user mobility, VPN solutions are becoming increasingly important to various organizations. This is especially so with the use of secure socket layer (SSL) VPN solutions whose main notion is to provide client-less VPN access to people from anywhere; moreover, remote access often originates from unmanaged resources. This necessitates administrators of a private network offering VPN service to ascertain the security compliance of a device before it is virtually added to the VPN. This is where Client Integrity Check (CIC) comes into picture. The CIC process is initiated before VPN access is granted (established) to make sure that the client workstation is secure enough to be given access to protected resources. This helps thwart security attacks such as “backdoor” attacks, etc.

Initially, an administrator of the VPN configures CIC policies and traffic policies. The CIC policies identify the configuration and information that are to be checked on a connecting client workstation and map that to specific security access levels. The traffic policies configure attributes of the VPN session to enforce the assigned security access level during a particular VPN session.

It is within this context that processing of the VPN security compliance service is now discussed with reference to the FIG. 1.

At 110, the VPN security compliance service detects a successful login into a secure network having secure resources. For example, the secure network can be an enterprise's Intranet that a user (employee) accesses via a VPN connection. The user authenticates to a VPN establishment service from a client workstation over the network (e.g., Internet). Upon successful login and before the user is notified and the VPN session is established, the VPN security compliance service is notified that a VPN session for a particular user is about to be initiated. This informs the VPN security compliance service that CIC processing is to take place and that the VPN traffic policies for the VPN session are to be configured in the manners discussed herein and below.

According to an embodiment, at 111, the VPN security compliance service dynamically downloads and installs a CIC service on the client workstation of the user after the user is detected as being successfully logged into the network. The CIC service processes on the client workstation to enforce CIC policy and to report back metrics regarding the client workstation's processing environment (discussed below).

At 120, the VPN security compliance service performs a CIC against the processing environment of the client workstation.

Continuing with the embodiment, at 111, the VPN security compliance service, at 121, processes the CIC service on the client workstation of the user to perform the CIC.

Accordingly, at 122, the VPN security compliance service receives back from the CIC service configuration information. The configuration information received back from the CIC service is defined by an administrative policy that accompanies or is configured within the CIC service when it is downloaded to the client workstation.

In an embodiment, at 123, the VPN security compliance service identifies the configuration information as a variety of conditions that exist on the client workstation at the time that the CIC service enforces the administrative policy. The information can include, but is not limited to conditions such as: whether a particular software application is present on the client workstation; whether a particular file or data set is present on the client workstation; whether a particular registry key is set on the client workstation; whether a particular version of a file is present on the client workstation; whether a particular version of a particular software application is present on the client workstation; whether a particular version and type of an OS is present and running on the client workstation; whether a particular resource or antivirus software service is present and running on the client workstation; and/or a complete listing of all running processes on the client workstation.

This configuration information details the configuration and processing environment of the client workstation. This permits the VPN security compliance service to identify what it believes to be security compliance on the client workstation. That is, the details of the configuration information can be compared against security policy, which may also be previously defined by an administrator, and this permits a security access level to be assigned to the user and the client workstation for use during the VPN session that is being established (discussed more completely below).

So, at 130, the VPN security compliance service assigns a security access level to the user and the client workstation for a VPN session for resources of the secure network in response to the content of information supplied in the configuration information, which the CIC (processing on the client workstation) supplied back to the VPN security compliance service.

According to an embodiment, at 131, the VPN security compliance service assigns a particular security access level in response to the configuration information and a security access policy. In other words, the content of information supplied in the configuration information is mapped via instructions in the security access policy to a particular security access level.

At 140, the VPN security compliance service sets a traffic policy for communication between the user and the resources during the VPN session. The traffic policy is set or configured against the VPN session to enforce the set security access level.

For example, at 141, the VPN security compliance service configures a variety of VPN session attributes to enforce the security access level against the user and the resources of the secure network that the user accesses or may access during the VPN session. Some example attributes that define and restrict the VPN session include, but are not limited to: a network destination address, a destination mask, a communication port number, a user-defined access role, and/or processing actions to take. A processing action can include a variety of administrator defined automated actions, such as inspecting certain user access attempts during the VPN session to restrict them or to report on them, etc.

The techniques of the VPN security compliance service demonstrate a multi-level access control technique for VPN access. CIC policies and traffic policies are predefined by an administrator in response to the needs of the enterprise and in response to the desired level of security that the enterprise desires to enforce.

Again, some example CIC policies (configured in or supplied with the CIC service that processes on the client workstation) can include such things as: presence or absence of a particular piece of software (such as a particular antivirus software); presence or absence of a particular file or registry key set on the client workstation; any necessary version of a file; running processes on the client workstation; etc. Some example traffic policies configured against the VPN session before the user can access the VPN session include, but are not limited to: destination address, destination mask, port, protocol used, security role, and/or processing action.

Security levels are also assigned in response to the configuration information. That is, a particular security level reflects the security compliance of the client workstation (the CIC checks defined by the CIC policy). Again, each security level is associated with a particular security level; this permits the desired level of security to be enforced during the VPN session.

As an example processing scenario for the VPN security compliance service consider the following example. Initially, a user logs into a VPN (secure network) at 110. A CIC service is executed on the client workstation at 120-122. The CIC service checks for software, patches, and other items that are configured to be checked for by CIC policy (previously defined by an administrator). The CIC service evaluates CIC policy on the client workstation in order of increasing security level. This establishes a particular security access level at 130. In response to the security access level, the VPN security compliance service sets traffic policy at 140 to enforce the security access level.

So, VPN access is granted based on the security compliance of a particular client workstation that the user uses to initially request a VPN session. In some cases, the administrator may also provide some actions to take when just a least amount of security is detected on the client workstation of the user. A least amount of security can be a failure of all CIC policies. In other words, the client workstation has no desired security but the user does successfully supply credentials from that workstation to access the VPN. In such a case, the administrator can, via the security policy enforced by the VPN security compliance service, give access to just a single resource that provides some form of remedial software; or redirect the user to a World-Wide Web (WWW) page that has more information on what the user needs to do in order to rectify the lack of security on the client workstation.

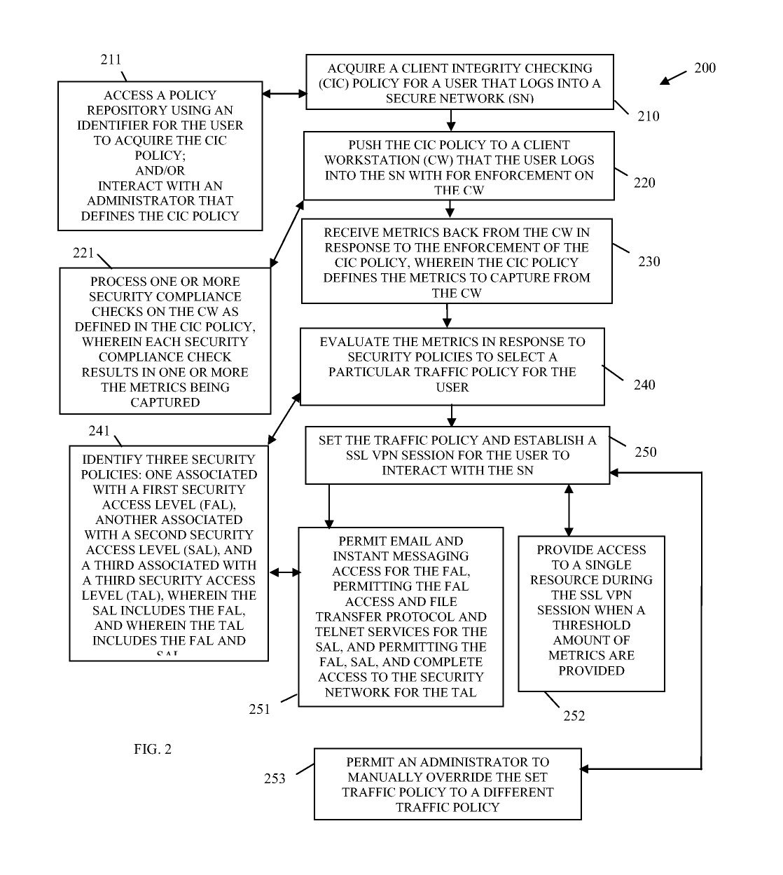

It is also noted that the security access level can be cumulative, such that higher assigned levels of security include all access rights to resources of the VPN session that lower assigned security levels have. In this way, the security access is multilevel or hierarchical in nature. This is discussed in greater detail below with reference to the method 200 of the FIG. 2.

It is now understood how VPN access can be based on security compliance of the client workstation that a user uses to access a VPN. The security access can vary and can be customized, such that the user is not outright provided automatically full access to resources of the VPN when the user authenticates to the VPN and is not automatically denied all access when the client workstation does not comply with all security requirements of an enterprise.

FIG. 2 is a diagram of another method 200 for setting security access during a VPN session, according to an example embodiment. The method 200 (herein after referred to as “client integrity checking (CIC) service”) is implemented in a machine-accessible and computer-readable medium and instructions. The instructions when processed by one or more machines (computer, processing device, etc.) perform the processing depicted in the FIG. 2. The CIC service is operational over a network and the network is wired, wireless, or a combination of wired and wireless.

The CIC service presents a different perspective and in some cases enhanced perspective of the VPN security compliance service represented by the method 100 of the FIG. 1.

At 210, the CIC service acquires a CIC policy for a user that logs into a secure network (VPN) of an enterprise. This can be achieved in a number of ways.

For example, at 211, the CIC service may use an identity assigned to the user that logs into the security network to access or index into a policy repository to acquire the CIC policy. In another case, the CIC service may interactively interact with an administrator that defines the CIC policy. It is noted that any CIC policy acquired from the policy repository was previously defined by the administrator. So, the CIC service can dynamically acquire the CIC policy via a policy repository that an administrator has previously detailed or the CIC service can dynamically interact with an administrator to receive a newly defined CIC policy on demand.

At 220, the CIC service dynamically pushes the CIC policy to a client workstation of the user. That is, the machine (client workstation) that the user uses to log into the secure network is dynamically supplied the CIC policy for enforcement once the user successfully authenticates to the secure network (VPN) and before a VPN session is permitted to proceed between the secure network and its resources and the user.

In an embodiment, at 221, the CIC service processes one or more security compliance checks on the client workstation in response to the dictates defined in the CIC policy. Each security compliance check results in one or more metrics being captured that define configuration information associated with a processing environment of the client workstation.

At 230, CIC service receives the metrics back from the client workstation in response to enforcement of the CIC policy. Again, the CIC policy defines the metrics that are being captured on the client workstation.

At 240, the CIC service evaluates the metrics in response to security policies for purposes of selecting a particular traffic policy for the user to use during the VPN session.

According to an embodiment, at 241, the CIC service identifies three security policies: a first security access level, a second security access level, and a third security access level. The second security access level include access permitted by the first security access level and the third security access level includes the access permitted by the first and second security access levels. So, the security is hierarchical or cumulative. It is noted that the number of security access levels can vary and can be defined by a configurable processing parameter or option or even be defined via another policy.

At 250, the CIC service sets the traffic policy and establishes the VPN session for the user to interact with the secure network (VPN) during a VPN session.

In an embodiment, at 251 (that compliments and expands the embodiment defined at 241); the CIC service permits email and instant message access during the VPN session for the first security access level. For the second security access level, the CIC service permits email access, instant messaging access, file transfer protocol (FTP) access, and telnet services. For the third security access level, the CIC service permits email access, instant messaging access, FTP services, telnet services, and full and complete access to all other resources available on the secure network.

According to an embodiment, at 252, the CIC service permits access to just a single and in some cases constrained feature/function resource during the VPN session when a minimal threshold amount of metrics are provided. So, if just one metric is satisfied from the client workstation or even no metrics are satisfied then a configured threshold may indicate as much and permit the CIC service to still allow access to at least one resource of the secure network and that one resource may include limited features or functions (remedial).

In still another case, at 253, the CIC service permits an administrator to manually override set traffic policy to a different traffic policy. This may be useful when the administrator (who has proper access rights) desires to permit an important user to access some resources for a limited time even when the client workstation of the user would not permit such access. It is noted that this can work the other way as well, such that the administrator may want to restrict access further to resources of the secure network during the SSL VPN session even when the client workstation may otherwise permit such access. Essentially, a manual override mechanism is implemented to permit administrator intervention on a case-by-case basis.

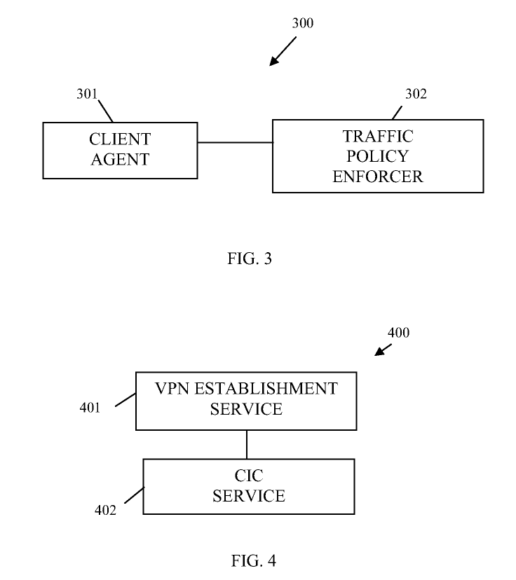

FIG. 3 is a diagram of a VPN security access establishment system 300, according to an example embodiment. The VPN security access establishment system 300 is implemented as instructions on or within a machine-accessible and computer-readable medium. The instructions when executed by machines of a network perform, among other things, processing depicted with respect to the methods 100 and 200 of the FIGS. 1 and 2, respective. The VPN security access establishment system 300 is also operational over a network, and the network is wired, wireless, or a combination of wired and wireless.

The VPN security access establishment system 300 includes a client agent 301 and a traffic policy enforcer 302. Each of these and their interactions with one another will now be discussed in turn.

The client agent 301 is implemented in a machine-accessible and computer-readable medium and is to process on a client workstation of the network. Some example processing associated with the client agent was provided above with reference to the methods 100 and 200 of the FIGS. 1 and 2, respective.

The client agent 301 is designed to be dynamically pushed, installed, and processed on the client workstation when a user attempts to establish a VPN session with resources of a secure network. In some cases, if the user is accessing the secure network that is not a first attempt, the client agent 301 may be pre-existing on the client workstation and is just initiated once the user attempts to establish a subsequent VPN session with the secure network.

The client agent 301 is preconfigured with directives to capture specific metrics about the processing environment configuration of the client workstation. These directives that define the metrics to be captured are predefined by administrative policy.

The metrics can define a variety of information, which was defined above with reference to the methods 100 and 200 of the FIGS. 1 and 2, respectively. For example, the one metric may instruct the client agent 301 to capture a version and type of operating system that is processing on the client workstation. Another metric may instruct the client agent 301 to capture whether the presence of a particular piece of software exists on the client workstation (such as antivirus software) and a particular version number for that software when it exists. As noted other metrics were discussed above with discussion of the FIGS. 1 and 2.

The traffic policy enforcer 302 is implemented in a machine-accessible and computer-readable medium and is to process on a server machine of the network. Example processing associated with the traffic policy enforcer 302 was presented in detail above with reference to the methods 100 and 200 of the FIGS. 1 and 2, respectively.

The traffic policy enforcer 302 receives metrics from the client agent 301 regarding client integrity checks for a processing environment of the client workstation of the user. In response to the metrics returned, the traffic policy enforcer 302 sets a security access level for the user during the VPN session.

In an embodiment, the traffic policy enforcer 302 ensures the security access level by configuring attributes for the VPN session that include a network destination address, a destination mask, a communication port number, a user-defined access role, and/or a processing action to take for each interaction attempted by the user during the VPN session.

The security access level is cumulative so that a higher value assigned to the security access level includes access rights permitted by lower security access levels that have lower security access assigned values. This was discussed above with reference to the FIGS. 1 and 2. So, a second security access level (level 2) includes all access rights that belong to a first security access level (level 1), etc.

FIG. 4 is a diagram of another VPN security access establishment system 400, according to an example embodiment. The VPN security access establishment system 400 is implemented as instructions on or within a machine-accessible and computer-readable medium. The instructions when executed by machines of a network perform, among other things, processing depicted with respect to the methods 100 and 200 of the FIGS. 1 and 2, respectively. The VPN security access establishment system 400 is also operational over a network, and the network is wired, wireless, or a combination of wired and wireless. The VPN security access establishment system 400 presents another and in some cases enhanced perspective of the VPN security access establishment system 300 represented by the FIG. 3.

The VPN security access establishment system 400 includes a VPN establishment service 401 and a client integrity checking (CIC) service 402. Each of these and their interactions with one another will now be discussed in turn.

The VPN establishment service 401 is implemented in a machine-accessible and computer-readable medium and processes on a server machine of the network.

The VPN establishment service 401 informs the CIC service 402 when a user successfully logs into the network. The VPN establishment service 401 also establishes and monitors the VPN session that is subsequently established after processing of the CIC service 302 completes.

The CIC service 402 is implemented in a machine-accessible and computer-readable medium and processes on the server machine and a client machine of the network. That is, the CIC service 402 includes a client portion that processes on the client machine and a server portion that processes on the server machine. Example processing associated with the CIC service was presented in detail above with reference to the methods 100 and 200 of the FIGS. I and 2, respectively, and with respect to the system 300 of the FIG. 3.

A server portion of the CIC service 302 pushes a CIC policy to a client portion of the CIC service 302. The client portion gathers metrics in compliance with the CIC policy and reports the metrics back to the server portion.

In response to the metrics, the server portion configures traffic policies for a VPN session of the user for subsequent interaction with secure resources of the server machine. The traffic policies enforce an assigned security access level that the user is to have during the VPN session.

In an embodiment, server portion identifies the CIC policy in response to an identity assigned to the user.

According to an embodiment, the metrics identify information for a configuration of a processing environment of the client machine of the user.

Also, the CIC policy is predefined by an administrator and acquired from a policy repository. In one case, the CIC policy may be interactively and dynamically defined by the administrator on an as needed basis.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
detecting a successful login of a user into a secure network and originating from a client workstation;
performing a client integrity check against a processing environment of the client workstation;
assigning a security access level to the user and the client workstation for a virtual private network (VPN) session with resources of the secure network in response to the client integrity check; and
setting a traffic policy for communication between the user and the resources during the VPN session in response to the security access level.

2. The method of claim 1, wherein detecting further includes dynamically downloading and installing a client integrity service on the client workstation in response to the successful login of the user to the secure network.

3. The method of claim 2, wherein performing further includes processing the client integrity service on the client workstation to perform the client integrity check.

4. The method of claim 3, wherein performing further includes receiving back from the client integrity service configuration information for the client workstation, wherein the configuration information captured by the client integrity service is defined by an administrator policy that accompanies the client integrity service when it is downloaded to the client workstation.

5. The method of claim 4, wherein receiving further includes identifying in the configuration information one or more of the following conditions: whether a particular software application is present on the client workstation, whether a particular file or dataset is present on the client workstation, whether a particular registry key is set on the client workstation, whether a particular version of a file is present on the client workstation, whether a particular version of a software application is present on the client workstation, whether a particular version of an operating system is running on the client workstation, and a listing of processes that are currently running on the client workstation.

6. The method of claim 5, wherein assigning further includes resolving a particular security access level in response to the configuration information and a security policy.

7. The method of claim 1, wherein setting further includes configuring attributes for the VPN session to enforce the security access level, wherein the attributes include one or more of the following: a network destination address, a destination mask, a communication port number, a user-defined access role, and a processing action to take.

8. A machine-implemented method, comprising:
acquiring a client integrity checking (CIC) policy for a user that logs into a secure network;
pushing the CIC policy to a client workstation that the user logs into the secure network with for enforcement on the client workstation;
receiving metrics back from the client workstation in response to the enforcement of the CIC policy, wherein the CIC policy defines the metrics to capture from the client workstation;
evaluating the metrics in response to security policies to select a particular traffic policy for the user; and
setting the traffic policy and establishing a secure socket layer (SSL) virtual private network (VPN) session for the user to interact with the secure network.

9. The method of claim 8, wherein acquiring further includes one or more of the following:
accessing a policy repository using an identifier for the user to acquire the CIC policy; and
interacting with an administrator that defines the CIC policy.

10. The method of claim 8, wherein pushing further includes processing one or more security compliance checks on the client workstation as defined in the CIC policy, wherein each security compliance check results in one or more the metrics being captured.

11. The method of claim 8, wherein evaluating further includes identifying three security policies: one associated with a first security access level, another associated with a second security access level, and a third associated with a third security access level, wherein the second security access level includes the first security access level, and wherein the third security access level includes the first and second security access levels.

12. The method of claim 11, wherein setting further includes permitting email and instant messaging access for the first security access level, permitting the first security level access and file transfer protocol and telnet services for the second security access level, and permitting the first and second security access levels and complete access to the security network for the third security access level.

13. The method of claim 8, wherein setting further includes providing access to a single resource during the SSL VPN session when a threshold amount of metrics are provided.

14. The method of claim 8, wherein setting further includes permitting an administrator to manually override the set traffic policy to a different traffic policy.

15. A machine-implemented method, comprising:
a client agent implemented in a machine-accessible and computer-readable medium and to process on client workstation of a network; and
a traffic policy enforcer implemented in a machine-accessible and computer-readable medium and to process on a server machine of the network;
wherein the client agent is dynamically downloaded and initiated on the client workstation from the server machine when a user first attempts to establish a virtual private network (VPN) session with secure resources of the network, and wherein when the user successfully logs into the network the traffic policy enforcer receives metrics from the client agent regarding client integrity checks for a processing environment of the client workstation of the user and in response thereto the traffic policy enforcer sets a security access level for the user during the VPN session.

16. The system of claim 15, wherein the metrics gathered by the client agent are preconfigured in the client agent in response to an administrative policy.

17. The system of claim 15, wherein the metrics identify a version and a type of operating system being used on the client workstation and identifies a version and a type of virus scan software executing on the client workstation.

18. The system of claim 17, wherein the metrics further identify whether a presence and a version of particular software services exists on the client workstation.

19. The system of claim 15, wherein the traffic policy enforcer ensures the security access level by configuring attributes for the VPN session that include a network destination address, a destination mask, a communication port number, a user-defined access role, and a processing action to take for each interaction attempted by the user during the VPN session.

20. The system of claim 15, wherein the security access level is cumulative so that a higher value assigned to the security access level includes access rights permitted by lower security access levels.

21. A machine-implemented system, comprising:
a virtual private network (VPN) establishment service implemented in a machine-accessible and computer-readable medium and processing on a server machine of a network; and
a client integrity checking (CIC) service implemented in a machine-accessible and computer-readable medium and to process on the server machine and on a client machine of the network;
wherein the VPN establishment service informs the CIC service when a user successfully logs into the network, and wherein a server portion of the CIC service pushes a CIC policy to a client portion of the CIC service, the client portion gathers metrics in compliance with the CIC policy and reports the metrics back to the server portion, in response to the metrics the server portion configures traffic policies for a VPN session of the user for subsequent interaction with secure resources of the server machine, and wherein the traffic policies enforce an assigned security access level that the user is to have during the VPN session.

22. The system of claim 21, wherein the server portion identifies the CIC policy in response to an identity assigned to the user.

23. The system of claim 21, wherein the metrics identify information for a configuration of a processing environment of the client machine of the user.

24. The system of claim 21, wherein the CIC policy is predefined by an administrator and acquired from a policy repository.
